(19) United States
(12) Patent Application Publication
(10) Pub. No.: US 2007/0155447 A1
(43) Pub. Date: Jul. 5, 2007

(54) Sliding motion arrangement for electronic devices

(76) Inventor: Ryszard J. Gordecki, Green Oaks, IL (US)

Correspondence Address: MOTOROLA INC, 600 NORTH US HIGHWAY 45, ROOM AS437, LIBERTYVILLE, IL, 60048-5343, US

(21) Appl. No.: 11/321,020

(22) Filed: Dec. 29, 2005

(51) Int. Cl. H04M 1/00

(52) U.S. Cl. 455/575.4; 455/575.1

(57) ABSTRACT

A sliding mechanism (104) is provided in an electronic device (101) including a housing having first and second portions (102, 103) movable between a closed position and an open position. The sliding mechanism (104) includes a cam plate (201, 1101) secured to the first portion (102) of the housing. A slider plate (204, 1104) is attached to the second portion (103) of the housing. A biasing member (308, 1108) couples the cam plate (201, 1101) to the slider plate (204, 1104). Sliding movement of the first portion (102) of the housing relative to the second portion (103) of the housing actuates the biasing member (308, 1108) to urge the first and second housing portions (102, 103) towards the closed position or the open position of the electronic device (101).

### FIELD OF THE INVENTION

The present invention relates generally to sliding-motion arrangements for electronic devices.

### BACKGROUND

The development of portable electronic devices can be characterized, at least in part, by a drive towards smaller size and greater functionality. Although the number of functions available is almost solely a matter of technological progress, miniaturization is limited by human factors such as biometrics. Thus, as the capabilities of electronic devices increase, the abilities of a user to select and control these functions becomes more difficult. One example of this paradox is illustrated in mobile electronic devices such as cell phones. Features such as internet access, text messaging, video streaming, and music storage/replay are being added to cell phones on a frequent basis, while the size of cell phones is decreasing. At the same time, the body of the device must be of sufficient size to accommodate the placement of usable control interfaces.

Several solutions to this dilemma have been brought forward. The most popular of these is a “clamshell” structure, wherein the device is hinged near its center. Clamshell structures present a compact package when folded, to facilitate storage of the device in a pocket or purse. When the device is unfolded for use, a full array of controls and displays becomes accessible. Furthermore, clamshell structure can be configured to open to approximately 155°, thus providing an advantageous angular position between the earpiece speaker and the mouthpiece microphone of the mobile electronic device.

Another proposed solution is the provision of a sliding mechanism. In these arrangements, portions of the device are connected by a mechanism that permits one portion to slide relative to another, allowing the device to alternate between compact and extended positions. Some sliding mechanisms are provided with a “curved” slider, which approximates the advantageous angular positioning of the clamshell structure.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a perspective view of an electronic device with a sliding mechanism in a closed position in accordance with an embodiment.

FIG. 2 illustrates a perspective view of an electronic device with a sliding mechanism in an extended position in accordance with an embodiment.

FIG. 3 illustrates a front elevational view of a slide mechanism in accordance with an embodiment.

FIG. 4 illustrates C-shaped cam slots.

FIG. 5 illustrates S-shaped cam slots.

FIG. 6 illustrates angular cam slots.

FIG. 7 illustrates a front elevational view of a slide mechanism in an upper position in accordance with an embodiment.

FIG. 8 illustrates a front elevational view of a slide mechanism in a middle position in accordance with an embodiment.

FIG. 9 illustrates a front elevational view of a slide mechanism in a lower position in accordance with an embodiment.

FIG. 10 illustrates a slide mechanism secured to housing walls of an electronic device in accordance with an embodiment.

FIG. 11 illustrates a front elevational view of a slide mechanism in a middle position in accordance with an alternative embodiment

### DETAILED DESCRIPTION

Before describing in detail certain illustrative embodiments, it should be observed that the embodiments reside primarily in combinations of method steps and apparatus components related to sliding arrangements in electronic devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

An electronic device has a first housing portion and a second housing portion that slide relative to each other to result in compact and extended positions (as well as intermediate positions). The sliding mechanism includes a cam plate secured to the first housing portion and a slider plate attached to the second housing portion. A biasing mechanism attaches the cam plate to the slider plate and urges the first housing portion and the second housing portion out of any intermediate position and toward either the compact or extended position.

The biasing mechanism can be an elastic biasing member (such as an expansion spring, a compression spring, or an elastic band) and a cam (such as a slot or track) having a geometry so as to create the bi-stable effect of urging the first housing portion and the second housing portion out of any intermediate position and toward either the compact or extended position.

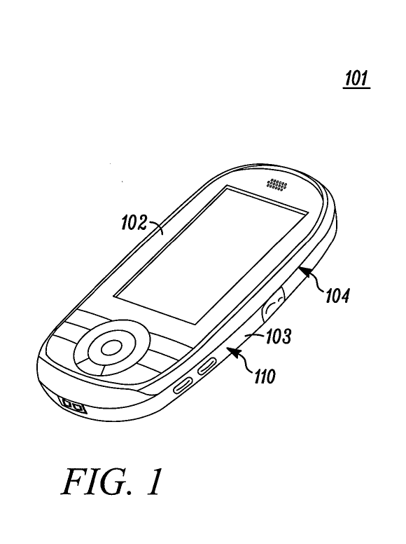

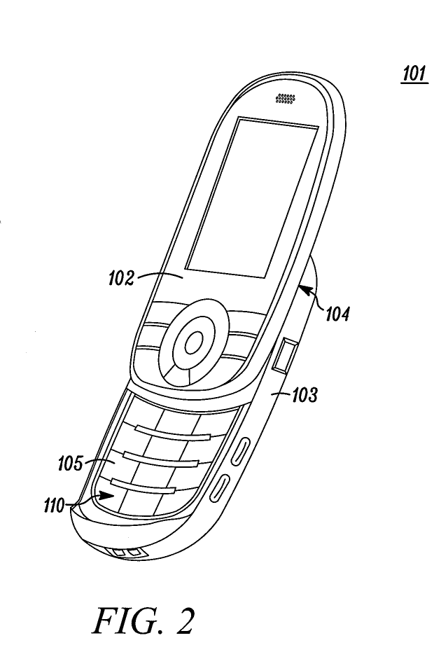

An embodiment of an electronic device 101 incorporating a sliding arrangement is shown in FIG. 1 and FIG. 2. Although the electronic device 101 is illustrated as a mobile station (also called a cellular telephone or user equipment), it is also contemplated that a sliding arrangement described herein can be implemented on other electronic devices in which selective compactness may be a desirable function, such as palmtop computers, portable audio/video devices, and the like. FIG. 1 shows the electronic device 101 in a compact, closed configuration and FIG. 2 shows the electronic device 101 in an open, extended configuration.

The electronic device 101 includes a housing having a first portion 102 and a second portion 103. Although the second portion 103 is shown to have a curvature on a front surface 110, the sliding arrangement can also be applied to a device with a planar front surface (best seen in FIG. 2). A sliding mechanism 104 (described in detail infra) permits the second portion 103 to slide from a closed, fully-compressed position (shown in FIG. 1) to an open, fully-extended position (shown in FIG. 2). In an embodiment, the sliding action exposes additional control elements 105 (shown in FIG. 2) so that they are accessible to a user of the device 101.

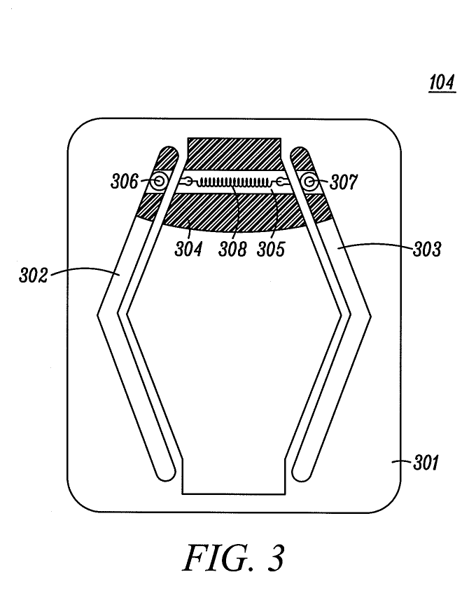

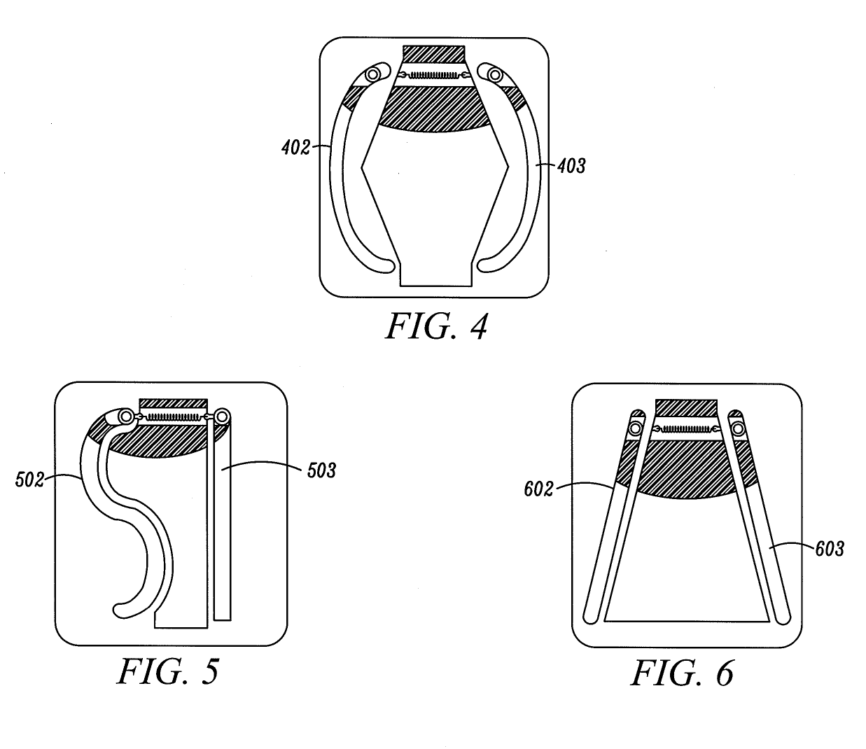

An illustrative embodiment of the sliding mechanism 104 is shown in FIG. 3. The sliding mechanism 104 includes a cam plate 301 having a pair of cams 302, 303, implemented here as cam slots. The respective cams 302, 303 are configured to have a varying slope designed to accommodate any desired motion characteristic (speed, shape, end stops) of the sliding mechanism. In the illustrated embodiment, the cams 302, 303 are generally chevron-shaped, oriented in opposite directions. Alternatively, the cams 302, 303 could be implemented as opposed “C”-shaped curved slots 402, 403 as shown in FIG. 4, “S”-shaped curved slots 502 as shown in FIG. 5, or opposed slanted angular slots 602, 603 as shown in FIG. 6. It is also contemplated that the cams can be asymmetrical as shown in FIG. 5, for example, a relatively straight linear slot 503 provided along with a chevron-shaped slot, C-shaped slot, S-shaped slot, or angular slot. Various cam slot shapes can provide different stable positions. For example, angular slots would provide only one stable position, chevron-shaped and C-shaped slots provide stable positions in the compact and extended positions, while S-shaped slots would have stability in the compact, extended, and a middle position. The cam plate 301 is adapted and constructed to be secured to one portion of the housing 102 of the electronic device 101 by any suitable mechanism, for example, by a plurality of fasteners such as screws, with an adhesive, or by welding.

The sliding mechanism also includes a slider plate 304. The slider plate 304 is provided with a cam follower slot 305 in which a pair of cam followers 306, 307 are mounted for reciprocation. As shown here, the cam follower slot is a two-dimensional slot, but it can also be implemented as a three-dimensional tube. The cam followers 306, 307 extend through the respective cam slots 302, 303, and are attached together via a biasing member 308, here provided as a spring. Although the cam followers 306, 307 are shown here as rollers, one or more cam followers can be implemented as low-friction posts, pegs, or the like fabricated using a suitable material such as Teflon®. Low-friction posts would replace the rolling action of the rollers with a sliding movement while allowing the electronic device to tend toward an open (fully extended) or closed position. The biasing member 308 is an extension spring, i.e., the biasing member 308 is compressed in its normal or rest position, and exerts an inwardly-acting force as it is extended. It is contemplated that the biasing member can be provided as any suitable device for storing potential mechanical energy, such as a spring, elastic band, or the like. The cam followers 306, 307 and biasing member 308 cooperate with the cam slots 302, 303 to constitute a biasing mechanism for operation of the sliding mechanism. The slider plate 304 is adapted and constructed to be secured to the other portion of the housing 103 of the electronic device 101 by any suitable mechanism, for example, by a plurality of fasteners such as screws, with an adhesive, or by welding. Although the cam plate 301 and the slider plate 304 are shown in this embodiment as components separate from the first portion 102 and the second portion 103 of a housing, the cam plate 301 or the slider plate 304, or both, could be part of their respective housing portions and integrally formed therein and thereon.

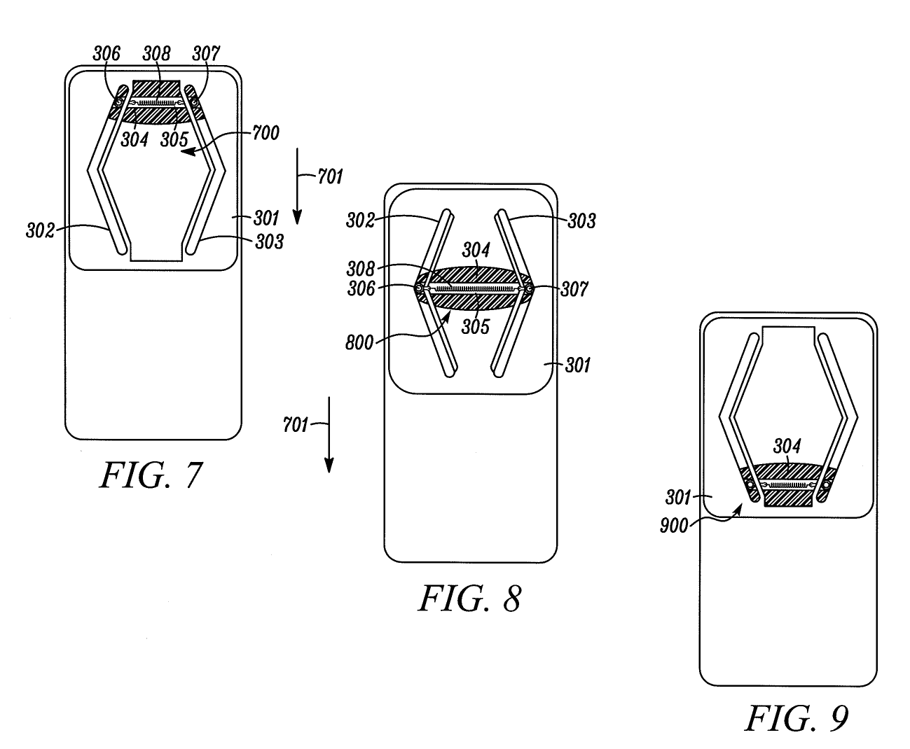

Operation of the sliding mechanism 104 is illustrated in FIGS. 7-9. In FIG. 7, the slider plate 304 is shown in its uppermost position 700. In this embodiment, when the slider plate 304 is in the uppermost position, the electronic device 101 is in its most extended position as shown in FIG. 2. With the cam slots 302, 303 sloped as shown, the force exerted by the biasing member 308 biases the slider plate 304 to maintain its stable position. As the slider plate 304 is moved downwardly in the direction of arrow 701, the cam followers 306, 307 travel outwardly within the cam follower slot 305, and the biasing member 308 exerts an opposing force until the slider plate 304 is in its middle position 800, shown in FIG. 8. Before the slider plate 304 reaches the middle position 800, cessation of force in the direction of arrow 701 will allow the biasing member 308 to exert enough force on the cam followers 306, 307 for the slide plate 304 to return to the uppermost position 700. Continued movement in the direction of arrow 701 moves the cam followers 306, 307 into the lower ends of the cam slots 302, 303, and the cam followers 306, 307 move towards one another in the cam follower slot 305. With the slope of the cam slots 302, 303 as shown, the force of the biasing member 308 urges the slider plate 304 into its lowermost position 900, as shown in FIG. 9. When the slider plate 304 is in its lowermost position 900, the electronic device 101 is fully closed as shown in FIG. 1. As shown in FIG. 1, additional control elements 105 are fully concealed when the electronic device 101 is in its fully closed position.

Opening of the electronic device 101 occurs in the reverse of the movement arrow 701 shown in FIGS. 7-9. As the slider plate 304 is moved upwardly from the lowermost position 900, the cam followers 306, 307 travel outwardly within the cam follower slot 305, and the biasing member 308 exerts an opposing force until the slider plate 304 is in its middle position 800. Until the slider plate 304 is in the middle position 800, release of force in the upward direction will allow the biasing member 308 to exert enough force on the cam followers 306, 307 for the slide plate 304 to return to the lowermost position 900. Continued upward movement moves the cam followers 306, 307 into the upper ends of the cam slots 302, 303, and the cam followers 306, 307 move towards one another in the cam follower slot 305. With the slope of the cam slots 302, 303 as shown, the force of the biasing member 308 urges the slider plate 304 into its uppermost position 700, as shown in FIG. 7.

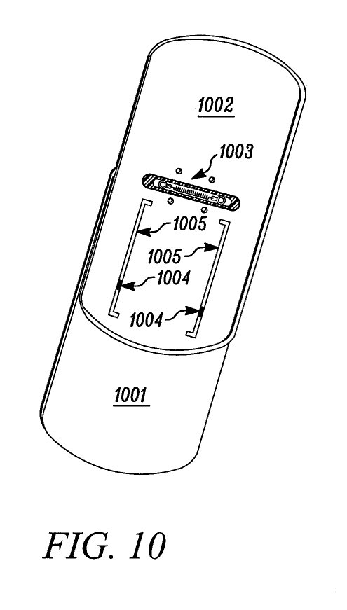

The cam plate 301 and slider plate 304 can be affixed to respective walls of the housing portions 102, 103 of the electronic device 101. In FIG. 10, the cam plate 301 is shown attached to a “first” wall 1001 of the second housing portion 103, and the slider plate 304 is shown attached to a “second” wall 1002 of the first housing portion 102. If desired, the first wall 1001 and the second wall 1002 have complementary curvatures to provide angular positioning of the first housing portion 102 and the second housing portion 103 when the electronic device 101 is fully extended. The wall 1002 includes a slot 1003 having the same general dimensions as the cam follower slot 305, and allows reciprocation of the cam follower in the same way in a compact design. The cam plate 301 can be provided with one or more guide extensions 1004 configured to cooperate with a corresponding number of guide slots 1005 in the housing wall 1002. As the slider plate 304 and wall 1002 move relative to the cam plate 301 and wall 1001, the guide extensions 1004 provide additional stability through their continuous contact with the guide slots 1005.

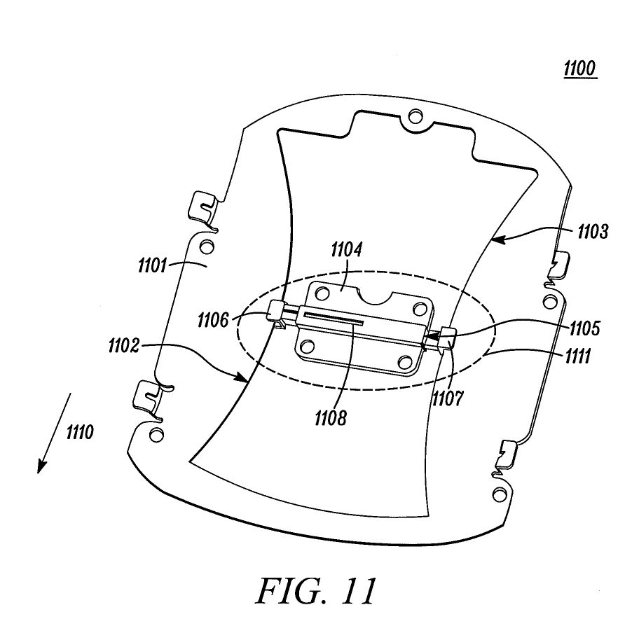

An alternative embodiment of a sliding mechanism 1100 is shown in FIG. 11. The sliding mechanism 1100 includes a cam plate 1101 having a pair of cams, here shown as generally C-shaped cam surfaces 1102, 1103. The respective cam surfaces 1102, 1103 are configured to have a varying slope designed to accommodate any desired motion characteristic (speed, shape, end stops) of the sliding mechanism. In the illustrated embodiment, the cam surfaces 1102, 1103 are oriented in opposite directions, with their curved portions sloping inwardly towards one another.

The sliding mechanism also includes a slider plate 1104. The slider plate 1104 is provided with a cam follower retaining slot 1105 in which a pair of cam followers 1106, 1107 are mounted for reciprocation. As can be seen, a cam follower slot can be a three-dimensional retainer such as the tube shown. The cam followers 1106, 1107 extend in opposite directions to come into contact with the respective cam surfaces 1102, 1103, and are held together via a biasing member, here provided as a spring 1108. The spring 1108 is a compression spring, i.e., the spring 1108 is extended in its normal or rest position, and exerts an outwardly-acting force as it is compressed.

Operation of the sliding mechanism 1100 is similar to that described with respect to the embodiment illustrated in FIGS. 7-9. When the slider plate 1104 is in an uppermost position, the electronic device 101 is in its most extended position. With the cams 1102, 1103 sloped as shown, the force exerted by the spring 1108 biases the slider plate 1104 to maintain its stable position. As the slider plate 1104 is moved downwardly in the direction of arrow 1110, the cam followers 1106, 1107 move inwardly by following the respective cam surfaces 1102, 1103, and the spring 1108 exerts an opposing force until the slider plate 304 is in its middle position 1111, shown in FIG. 11. Before the slider plate 1104 is in the middle position 1111, release of force in the direction of arrow 1110 will allow the spring 1108 to exert enough force on the cam followers 1106, 1107 for the slide plate 1104 to return to its uppermost position. Continued movement in the direction of arrow 1110 moves the cam followers 1106, 1107 into the lower ends of the cams 1102, 1103, and the cam followers 1106, 1107 move away from one another within the retaining slot 1105. With the slope of the cam surfaces 1102, 1103 as shown, the force of the spring 1108 urges the slider plate 1104 into its lowermost position. When the slider plate 1104 is in its lowermost position, the electronic device 101 is stable in its fully closed position. As shown in FIG. 2, additional control elements 105 are fully concealed when the electronic device 101 is in its fully closed position. Note that one or both of the cam followers 1106, 1107 can be replaced by slotted rollers or other geometries of cam followers fabricated from a suitable low-friction material such as Teflon®. Slotted rollers would replace the sliding action of the cam followers 1106, 1107 with a rolling movement while allowing the electronic device to tend toward an open (most extended) or closed (most compact) position.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. In an electronic device including a housing having a first portion and a second portion movable between a closed position and an open position, a sliding mechanism comprising:
a cam plate secured to the first portion;
a slider plate secured to the second portion; and
a biasing mechanism coupling the cam plate to the slider plate;
whereby sliding movement of the first portion relative to the second portion actuates the biasing mechanism to urge the first portion and the second portion towards one of the closed position and the open position.

2. A sliding mechanism in accordance with claim 1, wherein the biasing mechanism includes at least one cam on the cam plate.

3. A sliding mechanism in accordance with claim 2, wherein the at least one cam comprises a pair of cams.

4. A sliding mechanism in accordance with claim 3, wherein at least one of the pair of cams is generally chevron-shaped.

5. A sliding mechanism in accordance with claim 4, wherein the pair of cams comprise chevrons facing in opposing directions.

6. A sliding mechanism in accordance with claim 3, wherein at least one of the pair of cams is generally C-shaped.

7. A sliding mechanism in accordance with claim 3, wherein at least one of the pair of cams is generally S-shaped.

8. A sliding mechanism in accordance with claim 1, wherein the biasing mechanism includes at least one cam follower secured to the slider plate.

9. A sliding mechanism in accordance with claim 8, wherein the at least one cam follower comprises a pair of cam followers.

10. A sliding mechanism in accordance with claim 9, further comprising a cam follower slot formed on the slider plate, whereby the pair of cam followers is mounted for reciprocating movement within the cam follower slot.

11. A sliding mechanism in accordance with claim 10, further comprising a spring coupled between the pair of cam followers.

12. A sliding mechanism in accordance with claim 1, further comprising:
at least one guide slot formed on a wall of the second portion; and
at least one guide extension extending from the cam plate and received in the at least one guide slot.

13. A sliding mechanism in accordance with claim 12, wherein the at least one guide extension comprises a pair of guide extensions, and the at least one guide slot comprises a pair of guide slots.

14. A sliding mechanism in accordance with claim 1, wherein the cam plate is secured to a first curved wall of the first portion and wherein the slider plate is secured to a second curved wall of the second portion.

15. A sliding mechanism for use in an electronic device including a housing having a first housing portion and a second housing portion movable between a closed position and an open position, the sliding mechanism comprising the following:
a cam plate secured to the first housing portion;
at least one cam formed in the cam plate;
a slider plate secured to the second housing portion;
at least one cam follower secured to the slider plate and positioned for movement along the at least one cam; and
an elastic biasing member secured to the at least one cam follower.

16. A sliding mechanism in accordance with claim 15, wherein the at least one cam follower comprises first and second cam followers coupled together via the elastic biasing member.

17. A sliding mechanism in accordance with claim 15, wherein the elastic biasing member is a spring that is compressed in its normal position.

18. A sliding mechanism in accordance with claim 15, wherein the elastic biasing member is a spring that is extended in its normal position.

19. A sliding mechanism in accordance with claim 15, wherein the at least one cam is sloped to bias the first housing portion and the second housing portion into at least one of the open position and the closed position.

20. A sliding mechanism in accordance with claim 19, wherein the at least one cam follower is mounted for reciprocation in a direction generally perpendicular to a direction of relative movement of the first housing portion and the second housing portion.
